(19) United States
(12) Patent Application Publication
(10) Pub. No.: US 2021/0261081 A1
(43) Pub. Date: Aug. 26, 2021

(54) AIRBAG DEVICE

(71) Applicant: TOYODA GOSEI CO., LTD., Kiyosu-shi (JP)

(72) Inventors: Kenji FUJIMURA, Kiyosu-shi (JP); Yoshio MIZUNO, Kiyosu-shi (JP); Shigeyuki SUZUKI, Kiyosu-shi (JP); Bunpei MORITA, Kiyosu-shi (JP); Takatoshi YAJIMA, Kiyosu-shi (JP)

(21) Appl. No.: 17/159,394

(22) Filed: Jan. 27, 2021

(30) Foreign Application Priority Data
Feb. 26, 2020 (JP) 2020-030720

(51) Int. Cl. B60R 21/203; B60R 11/04

(52) U.S. Cl. CPC B60R 21/2035; B60R 2011/0003; B60R 11/04

(57) ABSTRACT

An airbag device includes an airbag, an airbag cover and a holder for holding the airbag and airbag cover. The airbag cover includes a door that is openable around a hinge at airbag deployment, and a side wall that is disposed around the door and attached to the holder. A functional component is held by a holding member and disposed in the door. The holding member includes a distal-side connecting portion that is fixed to the functional component, a root-side connecting portion that is secured to the holder, and a deformable portion that is disposed between the distal-side connecting portion and the root-side connecting portion. The deformable portion is configured to be plastically deformed at airbag deployment while having the distal-side connecting portion keep holding the functional component and suppressing a centrifugal force of the functional component from acting on the hinge of the door of the airbag cover.

### CROSS REFERENCE TO RELATED APPLICATIONS

The present application claims priority from Japanese Patent Application No. 2020-030720 of Fujimura et al., filed on Feb. 26, 2020, the entire disclosure of which is incorporated herein by reference.

### BACKGROUND

### 1. Technical Field

The present invention relates to an airbag device adapted to be mounted on a steering wheel and so on of a vehicle. More particularly, the invention relates to an airbag device that includes a functional component in a door of an airbag cover.

### 2. Description of Related Art

JP 2017-226348 A discloses a known airbag device for a vehicle that includes an airbag that is folded and inflatable with an inflation gas for deployment, an airbag cover that covers the airbag, and a holder that holds the airbag and airbag cover. The airbag cover includes a door that is configured to open around a hinge when pushed by the airbag at deployment, and a mounting wall that is disposed around the door and mounted on the holder. A functional component composed of a light-emitting display is disposed in the door.

In this airbag device, the functional component mounted on a back side of the door rotates with the door at airbag deployment. Therefore, the hinge of the door requires a strength to withstand a centrifugal force of the weight of not only the door but also the functional component. This problem is sometimes dealt with by adding a reinforcing member. However, a further increase in weight of the functional component will be difficult to cope with. It would be desirable to provide an airbag device in which a hinge portion of a door of an airbag cover does not require a major reinforcement despite of presence of a functional component in the door.

### SUMMARY

An exemplary embodiment of the invention relates to an airbag device that includes an airbag that is folded and is configured to unfold and be inflated with an inflation gas; an airbag cover that covers the airbag, the airbag cover including a door that is configured to open around a hinge portion when pushed by the airbag as being inflated, and a side wall that is disposed around the door; a holder that is coupled with the side wall of the airbag cover and holds the airbag and airbag cover; a functional component disposed in the door; and a holding member that is secured to the functional component and holds the functional component, the holding member being plastically deformable. The holding member includes a distal-side connecting portion that is fixed to the functional component, a root-side connecting portion that is secured to the holder, and a deformable portion that is disposed between the distal-side connecting portion and the root-side connecting portion. The deformable portion is configured to be plastically deformed at airbag deployment while having the distal-side connecting portion keep holding the functional component and suppressing a centrifugal force of the functional component from acting on the hinge portion of the door of the airbag cover.

### BRIEF DESCRIPTION OF DRAWINGS

FIG. 1 is a schematic plan view of a steering wheel equipped with an airbag device in accordance with a first exemplary embodiment.

FIG. 2 is a schematic vertical sectional view taken along a front and rear direction of the steering wheel of FIG. 1.

FIG. 3 is a schematic vertical sectional view of the airbag device of FIG. 1 prior to opening of a door, taken along line III-III of FIG. 1.

FIG. 4 is a schematic vertical sectional view of the airbag device of FIG. 1 as the door has been opened, taken along line III-III of FIG. 1.

FIG. 5 is a schematic exploded perspective view of the airbag device of FIG. 1.

FIG. 6 illustrates an assembling of a holding member with an airbag cover in the first exemplary embodiment.

FIG. 7 is a schematic exploded perspective view of an airbag device in accordance with a second exemplary embodiment.

FIG. 8 is a schematic vertical sectional view of the airbag device of FIG. 7 prior to opening of a door.

FIG. 9 is a schematic vertical sectional view of the airbag device of FIG. 7 as the door has been opened.

FIGS. 10 and 11 illustrates an assembling process of the airbag device of FIG. 7 in order.

FIG. 12 is a schematic sectional view of a modification of the airbag device in accordance with the second exemplary embodiment.

### DETAILED DESCRIPTION

Exemplary embodiments of the invention are described below with reference to the accompanying drawings. However, the invention is not limited to the embodiments disclosed herein. All modifications within the appended claims and equivalents relative thereto are intended to be encompassed in the scope of the claims.

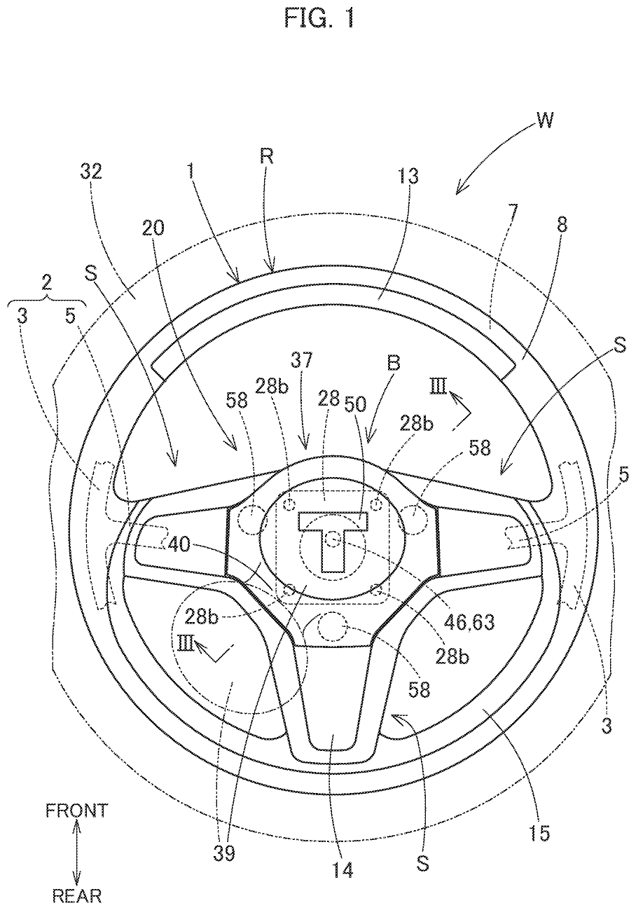

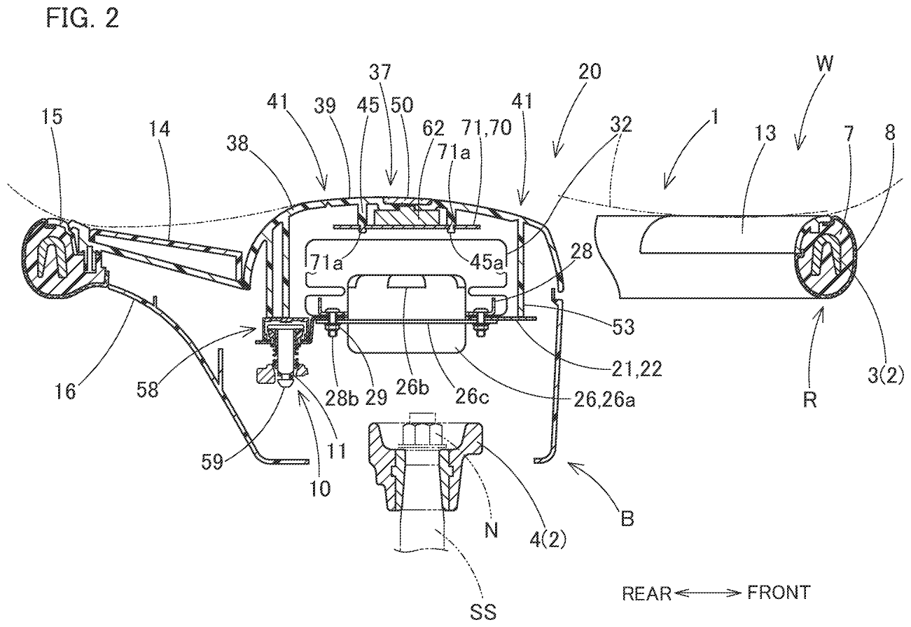

As shown in FIGS. 1 and 2, an airbag device 20 in accordance with a first exemplary embodiment is mounted on a steering wheel W of a vehicle. The steering wheel W includes a wheel body 1 and the airbag device 20. The wheel body 1 includes a rim portion or grip R for holding for steering, a boss section B which is disposed at the center of the rim portion (i.e. grip) R, and one or more spokes S which interconnect the boss section B and the rim portion R. The airbag device 20 is mounted on top of the boss section B.

In this disclosure, up-down, left-right, and front-rear directions are based on the vehicle as steered straight ahead with the steering wheel W nut N fixed to a steering shaft (FIG. 2). Specifically, the up and down direction corresponds to an up and down direction extending along an axial direction of the steering shaft SS. The left and right direction corresponds to a left and right direction of the vehicle which is orthogonal to the axial direction of the steering shaft SS. The front and rear direction corresponds to a front and rear direction of the vehicle which is orthogonal to the axial direction of the steering shaft SS, as shown in FIG. 1.

Referring to FIGS. 1 and 2, the wheel body 1 includes a skeleton 2 of such a shape that the rim portion R, boss section B and spokes S are interconnected, and a cladding layer 7 that covers the skeleton 2 at the rim portion R and regions of the spokes S adjoining the rim portion R. The cladding layer 7 is fabricated from urethane or the like. A leather is mounted around the cladding layer 7. A decorating garnish 13 and a decorating garnish 15 are disposed in an inner side of a front and a rear portion of the rim portion R, respectively.

The skeleton 2 includes a rim portion 3 which forms the rim portion R, a boss portion 4 which forms the boss section B and is connected to the steering shaft SS, and spoke portions 5 which form the spokes S and interconnect the rim portion 3 and boss portion 4. The spoke portions 5 of this embodiment are disposed only in the front left and right spokes S. A bezel 14 surrounding a later-described airbag cover 37 is disposed in the rear spoke S.

As shown in FIG. 2, a plurality of fixing portions 10 each for fixing a mounting pin 59 of each of a plurality of horn switch units 58 of the airbag device 20 are disposed in a periphery of the boss portion 4 of the skeleton 2, as described later. Each of the fixing portions 10 includes a retaining hole 11 that goes through the periphery of the boss portion 4 of the skeleton 2 while narrowing downwardly, and a retaining pin (reference numeral omitted) that is disposed in the underside of the boss portion 4 for retaining the leading end of the mounting pin 59. The retaining pin is composed of a spring member which is restorably bendable along the underside of the boss portion 4.

The wheel body 1 further includes a lower cover 16 in the underside of the boss section B, as shown in FIG. 2.

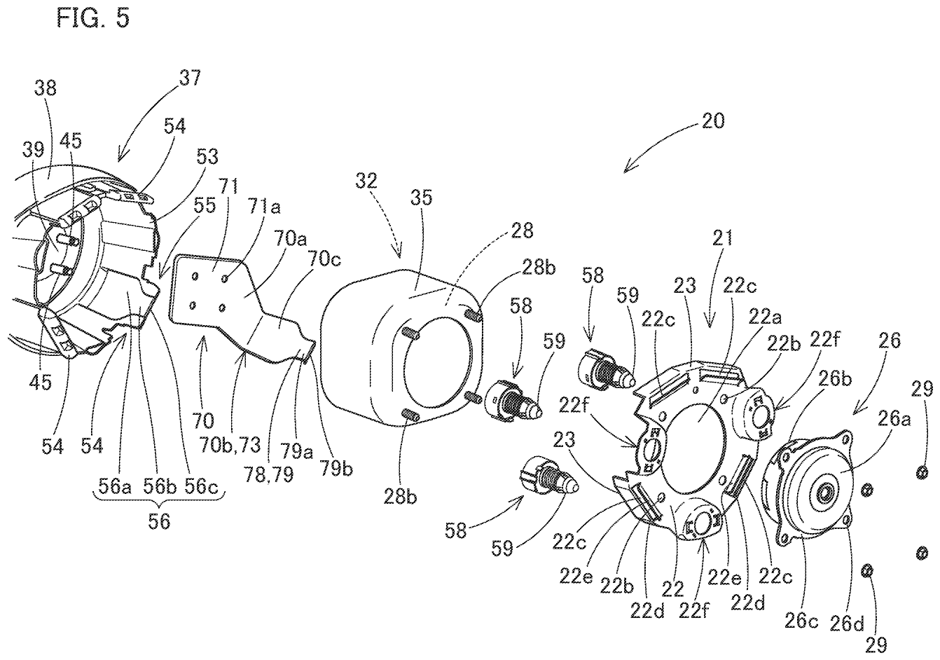

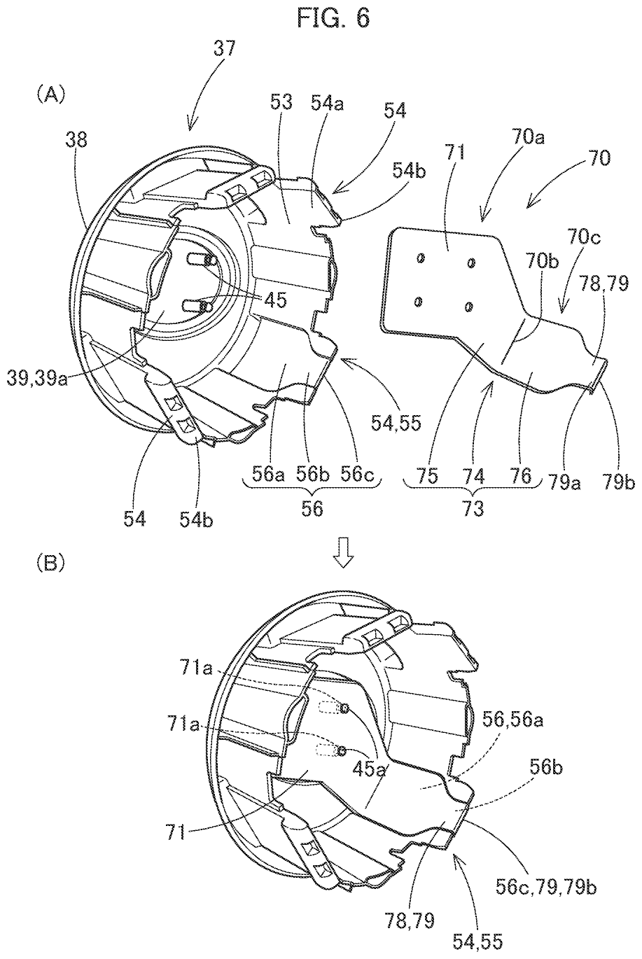

As shown in FIGS. 1 to 3 and 5, the airbag device 20 includes an airbag 32 inflatable with an inflation gas, an inflator 26 for feeding the airbag 32 with the inflation gas, an airbag cover 37 which covers the airbag 32 and is disposed above the boss section B of the steering wheel W, and a holder 21 which holds the airbag 32, inflator 26 and airbag cover 37, and a retainer 28. The airbag device 20 of this embodiment further includes a camera 62 as a functional component, in the airbag cover 37, and a holding member 70 that holds the camera 62.

The airbag 32 is designed to be inflated generally into a thick disc shape approximate a sphere. The airbag 32 includes a round inlet port 33 in the underside for receiving an inflation gas. There are four through holes 34a in the periphery 34 of the inlet port 33 for receiving later-described bolts 28b of the retainer 28.

The inflator 26 includes a body 26a which has a pot-like shape and a flange 26c which protrudes from an outer circumference of the body 26a in a square annular shape. The body 26a includes a plurality of gas discharge ports 26b for emitting an inflation gas in the upper portion. The flange 26c includes four through holes 26d for receiving the bolts 28b of the retainer 28.

The retainer 28 includes a square annular body 28a formed of a sheet metal, and four bolts 28b protruding downwardly from four corners of the body 28a. The retainer 28 is placed in the periphery 34 of the inlet port 33 inside the airbag 32 so that the bolts 28b go through the through holes 34a of the airbag 32, later-described through holes 22b of the holder 21, and the through holes 26d of the flange 26c of the inflator 26, and the bolts 28b are fastened with nuts 29. Thus the airbag 32 and inflator 26 are mounted on the holder 21.

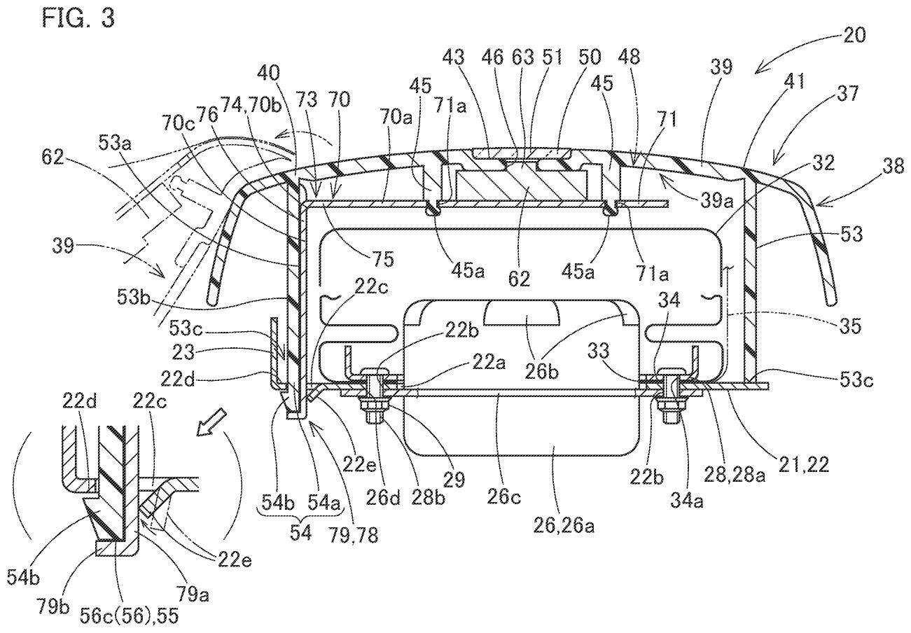

As shown in FIGS. 2 to 5, the holder 21 is made of sheet metal. The holder 21 includes a bottom wall 22 and a side wall 23 extending upward from the outer circumferential edge of the bottom wall 22. The bottom wall 22 is provided, at the center, a round insert hole 22a for receiving the inflator body 26a from below. In a periphery of the insert hole 22a, there are disposed four through holes 22b for receiving the bolts 28b of the retainer 28. The holder 21 further includes, in a vicinity of the outer circumferential edge, four retaining holes 22c used for coupling with the airbag cover 37. Each of the retaining holes 22c is designed to receive and retain a later-described retaining leg 54 of the airbag cover 37. As best shown in a parenthesis in FIG. 3, a peripheral edge of each of the retaining holes 22c in a side remote from the insert hole 22a serves as a retaining edge 22d to be engaged with the retaining leg 54. In a peripheral edge of each of the retaining holes 22c in a side near the insert hole 22a is a tongue 22e that is bent upward towards the retaining hole 22c at assembling of the airbag cover 37 and holder 21 in order to press the retaining leg 54 towards the retaining edge 22d for ensuring the retention of the retaining leg 54.

A plurality of (three, in this embodiment) horn switch units 58 are mounted each on a mounting seat 22f disposed in the bottom wall 22. The airbag device 20 is mounted on the boss portion 4 of the skeleton 2 of the steering wheel body 1 through the use of mounting pins 59 of the horn switch units 58.

Each of the horn switch units 58 internally includes a movable contact and a stationary contact (reference numerals omitted), and is configured to actuate a horn when the airbag device 20 is depressed to bring the movable contact into contact with the stationary contact.

The side wall 23 is disposed outside of the retaining holes 22c for supporting the retaining legs 54 of the airbag cover 37 as inserted into the retaining holes 22c when the retaining legs 54 bulge outwardly at airbag deployment.

As shown in FIGS. 1 to 5, the airbag cover 37 is fabricated from synthetic resin such as thermoplastic elastomer of olefin, and disposed above the boss section B in a vicinity of the center of the steering wheel W. The airbag cover 37 includes a ceiling wall 38 that is disposed in the upper portion and covers the airbag 32 as folded and stowed in the boss section B from above, and a side wall 53 that extends downwardly from the underside of the ceiling wall 38 generally in a cylindrical shape and covers an outer circumference of the airbag 32 entirely.

The ceiling wall 38 includes a door 39 which is formed generally into a disc shape and configured to open backward left when pushed by the airbag 32 as inflated. The door 39 includes a hinge 40 at the left rear edge, and a thinned breakable portion 41 in the circumferential edge. The breakable portion 41 is formed into a generally circular shape as viewed from above.

An ornament 50, which is formed generally into a T, is disposed on the upper surface of the door 39. The ornament 50 is fabricated from transparent synthetic resin such as PC resin, PMMA resin and PET resin. The front surface of the ornament 50 has been subjected to one-way mirror processing, so that the driver can be seen from airbag cover 37 side (i.e. from later-described camera 62 side) while the front (i.e. outer) surface is reflective like a mirror. That is, as viewed from the airbag cover 37 side, an entirety of the ornament 50 is a light-transmissive portion 51.

The door 39 further includes a recessed portion 43 for receiving the ornament 50 in the upper surface, and a through hole 46, in which a lens 63 of the camera 62 is disposed as described later, in the center of the recessed portion 43, as shown in FIG. 1. The ornament 50 is fixed inside the recessed portion 43 with adhesive or the like, in such a manner as to lid the through hole 46. The door 39 further includes, in the back side of the recessed portion 43 in the back side 39a, a plurality of (four, in this embodiment) retaining projections 45 that are connected with a later-described distal-side connecting portion 71 of the holding member 70, as described later. Each of the retaining projections 45 is inserted into a mounting hole 71a in the distal-side connecting portion 71 and retained there with its retaining head 45a, which has been fused to have an enlarged leading end.

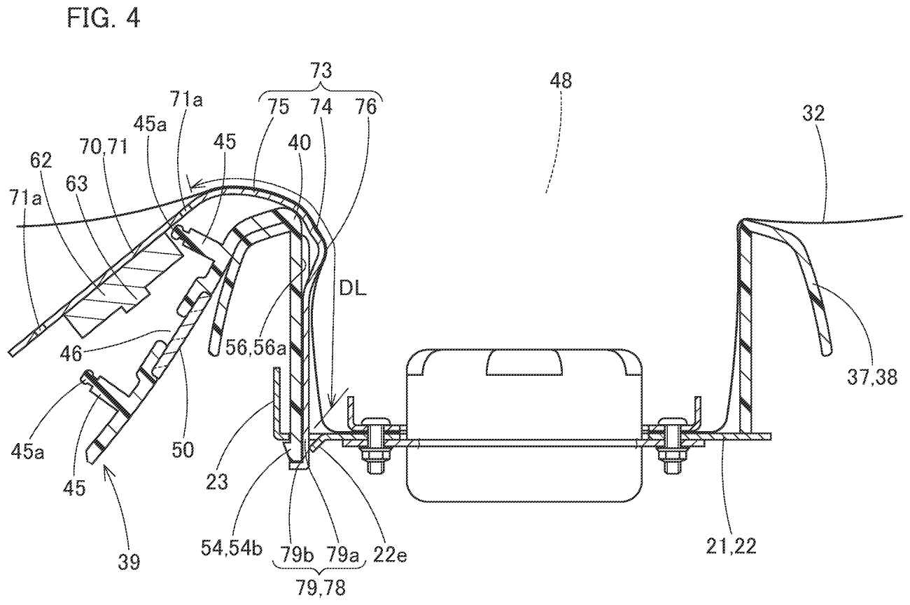

When the door 39 opens, the ornament 50 rotates together with the door 39, while the retaining projections 45 in the back side 39a of the door 39 pull out of the mounting holes 71a of the distal-side connecting portion 71 of the holding member 70, as shown in FIGS. 3 and 4. That is, the camera 62 as the functional component is prevented from dislocation with respect to the door 39 prior to opening of the door 39 through the use of the distal-side connecting portion 71 of the holding member 70, and is configured to be disengaged from the door 39 at opening of the door 39.

The airbag cover 37 includes a plurality of (four, in this embodiment) retaining legs 54 in the lower ends of the side wall 53. Each of the retaining legs 54 includes, in the lower end, a retaining head 54b protruding from an outer side 53b of the side wall 53 to be fixed to the holder 21 when inserted into the retaining hole 22c of the holder 21. Each of the retaining heads 54b is retained by an underside portion of the retaining edge 22d (i.e. outer edge) of the retaining hole 22c.

The airbag cover 37 as coupled with the holder 21 is prevented from moving in an up and down direction with respect to the holder 21. More particularly, the retaining legs 54 prevent the airbag cover 37 from moving upward, and an abutment of the leading end 53c of the side wall 53 against the bottom wall 22 of the holder 21 prevents the airbag cover 37 from moving downward, as shown in FIG. 3.

One of the retaining legs 54 disposed at the left rear position of the side wall 53 includes, in the inner surface 53a, a sunken portion 56 for receiving a later-described vertical plate portion 70c of the holding member 70 including a later-described root-side connecting portion 78. The sunken portion 56 includes a broad-width portion 56a in the upper side, a narrow-width portion 56b in the lower side, and an extended portion 56c extended from the narrow-width portion 56b and disposed in a vicinity of the leading end 55 of the retaining head 54b.

The camera 62 is configured to photograph eyes and its vicinity of the driver and send the shot data to the means for determining the driver condition, i.e. determining whether he is in a condition fit to operate the steering wheel W or in a condition unfit to operate, e.g. in a drowsy condition. The camera 62 is mounted on and held by the distal-side connecting portion 71 of the holding member 70 with not-shown fixing members such as bolts or rivets, in the back side 39a of the door 39.

The holding member 70 is made from plastically deformable metal such as steel and aluminum alloy (in this embodiment, the holding member 70 is made of a sheet metal of steel or the like). The holding member 70 includes a horizontal plate portion 70a which is disposed in the back side 39a of the door 39 of the airbag cover 37, a vertical plate portion 70c which is disposed in the inner surface 53a of the side wall 53 of the airbag cover 37, and a bent portion 70b which is disposed in an inner side of the hinge 40 of the airbag cover 37. The bent portion 70b is a generally L shaped portion where the horizontal plate portion 70a and vertical plate portion 70c intersect one another generally at 90°.

A leading end portion of the horizontal plate portion 70a serves as a distal-side connecting portion 71 on which the camera 62 is mounted, a lower end portion of the vertical plate portion 70c serves as a root-side connecting portion 78 connected to the holder 21, and the bent portion 70b and its vicinity serves as a deformable portion 73 that is configured to be deformed having the distal-side connecting portion 71 keep holding the camera 62 at airbag deployment.

The distal-side connecting portion 71 is formed into a generally flat plate and disposed in the back side 39a of the door 39. The distal-side connecting portion 71 includes a predetermined number of mounting holes 71a for receiving and retaining the retaining projections 45 of the door 39.

The vertical plate portion 70c is formed into a flat plate shaped to the inner surface 53a of the one of the retaining legs 54 disposed at the left rear of the side wall 53 of the airbag cover 70. The root-side connecting portion 78 is disposed at the lower end portion of the vertical plate portion 70c, and is composed of a retaining tongue 79 having a generally L sectional shape. The root-side connecting portion 78 is inserted into the retaining hole 22c of the holder 21 together with the one of the retaining legs 54. In this embodiment, the retaining tongue 79 (i.e. root-side connecting portion 78) is formed into such a shape as to fit the narrow-width portion 56b and extended portion 56c of the sunken portion 56 formed in the inner surface 53a of the one of the retaining legs 54, as described above. That is, the retaining tongue 79 as the root-side connecting portion 78 extends in an up and down direction at a vicinity of the lower end portion of the vertical plate portion 70c, and includes a flat neck portion 79a that is fitted in the narrow-width portion 56b of the sunken portion 56, and a hook portion 79b that bends perpendicularly from the lower end of the neck portion 79a to be engaged with the leading end surface 55 of the retaining head 54b of the one of the retaining legs 54. The hook portion 79b is formed into such a shape as to fit the extended portion 56c of the sunken portion 56.

The deformable portion 73 is a portion configured to be plastically deformed at airbag deployment while having the distal-side connecting portion 71 keep holding the camera 62 and suppressing a centrifugal force of the functional component (i.e. camera 62) from acting on the hinge 40. The deformable portion 73 of this embodiment includes a body 74 that is composed of the bent portion 70b, a distal-side extended portion 75 that extends towards the distal-side connecting portion 71 from the bent portion 70b, and a root-side extended portion 76 that extends towards the root-side connecting portion 78 from the bent portion 70b. These portions 74, 75 and 76 are to be plastically deformed at airbag deployment.

The holding member 70 is designed such that a portion from the root-side connecting portion 78 to short of the distal-side connecting portion 71 has such a length DL (FIG. 4) that would allow the deformable portion 73 to be plastically deformed and allow the distal-side connecting portion 71 to rotate so that an inertia force and so on of the camera 62 may not act on the hinge 40 of the door 39 when the distal-side connecting portion 71 is pushed by the inflating airbag 32. When the distal-side connecting portion 71 as holding the camera 62 is pushed by the airbag 32 at deployment, the bent portion 70b (i.e. the body 74 of the deformable portion 73) is plastically deformed, more particularly, unbent, and the distal-side extended portion 75 and the root-side extended portion 76 are plastically deformed as well. At this time, the door 39 is also pushed by the airbag 32 directly or indirectly with the interposition of the camera 32 and distal-side connecting portion 71, then opens around the hinge 40 due to breakage of the breakable portion 41.

Assembling of the airbag device 20 is now described. Firstly, the body 28a of the retainer 28 is inserted into the airbag 32 so that the bolts 28b protrude from the through holes 34a, then the airbag 32 is folded up. The airbag 32 as folded is wrapped by a wrapping member 35 for keeping the folded configuration.

The camera 62 is attached to the distal-side connecting portion 71 of the holding member 70, as well as the ornament 50 on the airbag cover 37. Then the vertical plate portion 70c of the holding member 70 is set in the sunken portion 56 of the side wall 53 of the airbag cover 37, the neck portion 79a of the retaining tongue 79 (i.e. root-side connecting portion 78) is fitted in the narrow-width potion 56b of the sunken portion 56, and the hook portion 79b is fitted in the extended portion 56c of the sunken portion 56 so as to be retained by the leading end surface 55 of the retaining leg 54. At the same time, the retaining projections 45, which protrude from the back surface 39a of the door 39, are put through the mounting holes 71a in the distal-side connecting portion 71, then the leading ends of the retaining projections 45 are fused to form the retaining heads 45a, while the lens 63 of the camera 62 is set in the through hole 46 of the door 39 from the back side 63a. Thus, the distal-side connecting portion 71 is coupled with the door 39, i.e. the holding member 70 is mounted on the airbag cover 37.

Subsequently, the bolts 28a of the retainer 28, which protrude from the folded airbag 32, are put through the through holes 22b of the holder 21, which has been provided with the horn switch units 58, while the body 26a of the inflator 26 is set in the insert hole 22a of the holder 21 from below so that the bolts 28b go through the through holes 26d of flange 26c of the inflator 26, then the bolts 28b are fastened with nuts 29. Thus, the airbag 32 and inflator 26 are mounted on the holder 21.

Thereafter, the retaining legs 54 of the side wall 53 of the airbag cover 37 are inserted into the retaining holes 22c of the holder 21, and the tongues 22e are pressed against the inner surfaces 53a of the retaining legs 54 so that the retaining heads 54b of the retaining legs 54 are retained by the retaining edges 22d of the retaining holes 22c. Thus, the airbag cover 37 is coupled with the holder 21, and the airbag device 20 is completed.

Thereafter, the airbag device 20 thus assembled is mounted on the steering wheel body 1, which has been mounted on the steering shaft SS, by inserting the mounting pins 59 of the horn switch units 58 into the retaining holes 11 of the fixing portions 10 of the wheel body 1. Thus, the airbag device 20 and steering wheel W are mounted on the vehicle.

Lead wires extending from the camera 62, which are used for delivering shot data and receiving power, though not shown, are arranged along the holding member 70 so as to be deformed together with the holding member 70. The lead wires are also arranged to go through the holder 21 and connected to a predetermined connector of the steering wheel body 1, together with not-shown lead wires extending from the inflator 26.

Operation of the airbag device 20 in accordance with the first exemplary embodiment is now described. In a condition in which the airbag device 20 is not yet activated, the camera 62, which is disposed in the back side 39a of the door 39, photographs the eyes and the vicinity of the driver through the light-transmissive portion 51 of the ornament 50 where the lens 63 is disposed, and sends the shot data to the means for determination. Since the camera 62 is disposed in the boss section B disposed on the upper side of the steering wheel W, it is able to photograph the driver as driving without being obstructed by the spokes S or the like.

When the airbag device 20 is activated, as shown in FIGS. 3 and 4, the inflator 26 emits an inflation gas from the gas discharge ports 26a, so that the airbag 32 is inflated with the gas, pushes the door 39 of the airbag cover 37 directly or indirectly with the interposition of the camera 32 and distal-side connecting portion 71 of the holding member 70. Then the breakable portion 41 is broken and the door 39 opens around the hinge 40, thus an airbag emergence opening 48 is formed in the ceiling wall 38 of the airbag cover 37. At the same time, the distal-side connecting portion 71 of the holding member 70, which holds the camera 62, is also pushed by the inflating airbag 32, so that the deformable portion 73 of the holding member 70, i.e. the body 74, the distal-side extended portion 75 and the root-side extended portion 76, is plastically deformed so as to allow the distal-side connecting portion 71 to rotate around the bent portion 70a and the vicinity through the airbag emergence opening 48. At this time, the retaining projections 45 of the door 39 of the airbag cover 37 pull out of the mounting holes 71a, so that the distal-side connecting portion 71 as holding the camera 62 is disengaged from the door 39. Accordingly, the camera 62 disengaged from the door 39 rotates as held by the distal-side connecting portion 71 of the holding member 70, thus does not strain a centrifugal force on the hinge 40 of the door 39. That is, in the airbag device 20 in accordance with the first exemplary embodiment, the hinge 40 of the door 39 is less subject to the centrifugal force of the camera 62 (as the functional component) disposed on the door 39 (in this embodiment, the hinge 40 is hardly subject to the centrifugal force). In other words, the hinge 40 has only to have a strength to resist a centrifugal force of only the door 39 with the ornament 50, thus can be designed easily in thickness, arrangement position or the like, without considering the weight of the camera 62. Here, although the holding member 70 is made from a plastically deformable material, it has shape retention property until being deformed, and is coupled to the robust holder 21 for holding the airbag 32 by the root-side connecting portion 78. Therefore, the holding member 70 is able to hold the camera 62 as the functional component steadily. Further, the holding member 70 facilitates assembling and positioning of the camera 62 with respect to the door 39 by inserting the retaining projections 45 into the mounting holes 71a.

Therefore, the configuration of the airbag device 20 in accordance with the first exemplary embodiment enables the camera (i.e. the functional component) 62 to be disposed in the door 39, which is openable at airbag deployment, with a least reinforcement of the hinge 40 of the door 39.

In the first exemplary embodiment, the functional component is composed of the camera 62 for photographing the vehicle occupant. Although the camera 62 has more weight than other functional components such as a light-emitting device, the configuration of the first exemplary embodiment suppresses the centrifugal force of the camera 62 from acting on the hinge 40 of the door 39 considerably, thus does not cause breakage of the hinge 40, and enables the camera 62 to be disposed in the back side 39a of the door 39 with no problem.

Other conceivable functional components includes a light-emitting device composed of a liquid crystal panel. Such a light-emitting device may also be secured to the holding member 70 and disposed in the back side of the door of the airbag cover.

The airbag device 20 in accordance with the exemplary embodiment is configured to be mounted in the boss section B of the steering wheel that is disposed in a vicinity of the center of the grip (i.e. rim portion) of the steering wheel, and the functional component is composed of the camera 62. This configuration serves for warning to the driver based on determination of the data shot by the camera 62, and serves for keeping appropriate driving.

In the airbag device 20 in accordance with the first exemplary embodiment, the side wall 53 of the airbag cover 37 includes a plurality of (four, in the illustrated embodiment) retaining legs 54 in the leading end 53c, and each of the retaining legs 54 includes the retaining head 54b that bulges outwardly. The holder 21 includes a plurality of retaining holes 22c, and the retaining legs 54 are respectively inserted into the retaining holes 22c so that each of the retaining heads 54b is retained by the retaining edge 22d of each of the retaining holes 22c, the retaining edge 22d being a part of the peripheral edge of the retaining hole 22c. The root-side connecting portion 78 of the holding member 70 is formed into a hook shape having a generally L sectional shape so as to be engaged with a region from the inner surface of one of the retaining legs 54 to the leading end 55 of the retaining head 54b of the one of the retaining legs 54. The root-side connecting portion 78 is inserted into one of the retaining holes 22c of the holder 21 and secured to the holder 21 together with the one of the retaining legs 54.

This configuration facilitates a coupling work of the holding member 70 to the holder 21. More particularly, if the retaining tongue 79 (i.e. the root-side connecting portion 78 formed into a hook shape) of the holding member 70 has been brought into engagement with the leading end (end surface) 55 of the retaining head 54b of the predetermined one of retaining legs 54 before inserting the retaining legs 54 of the airbag cover 37 into the retaining holes 22c of the holder 21, the retaining tongue 79 has only to be inserted into the predetermined retaining hole 22c together with the retaining leg 54. Doing so will make the retaining tongue 79 (i.e. the root-side connecting portion 78) of the holding member 70 retained by the holder 21 together with the retaining leg 54 when the retaining heads 54b of the retaining legs 54 are retained by the retaining edges 22d of the peripheral edges of the retaining holes 22c.

In the first exemplary embodiment, moreover, the holder 21 includes, in a part of the peripheral edge of each of the retaining holes 22c opposite from the retaining edge 22d, the tongue 22e that is bent towards the retaining hole 22c and presses the retaining leg 54 as inserted through the retaining hole 22c towards the retaining edge 22d. With this configuration, after the retaining legs 54 have been inserted into the retaining holes 22c of the holder 21, if the tongues 22e are bent to press the retaining legs 54 toward the retaining edges 22d, the engagement between the retaining heads 54b of the retaining legs 54 and the retaining edges 22d of the retaining holes 22c in the holder 21 becomes stronger. As for the retaining leg 54 that is inserted into the retaining hole 22c with the retaining tongue 79 (i.e. the root-side connecting portion 78) of the holding member 70, the coupling of the root-side connecting portion 78 and the holder 21 becomes stronger as well, as can be seen in the parenthesis of FIG. 3.

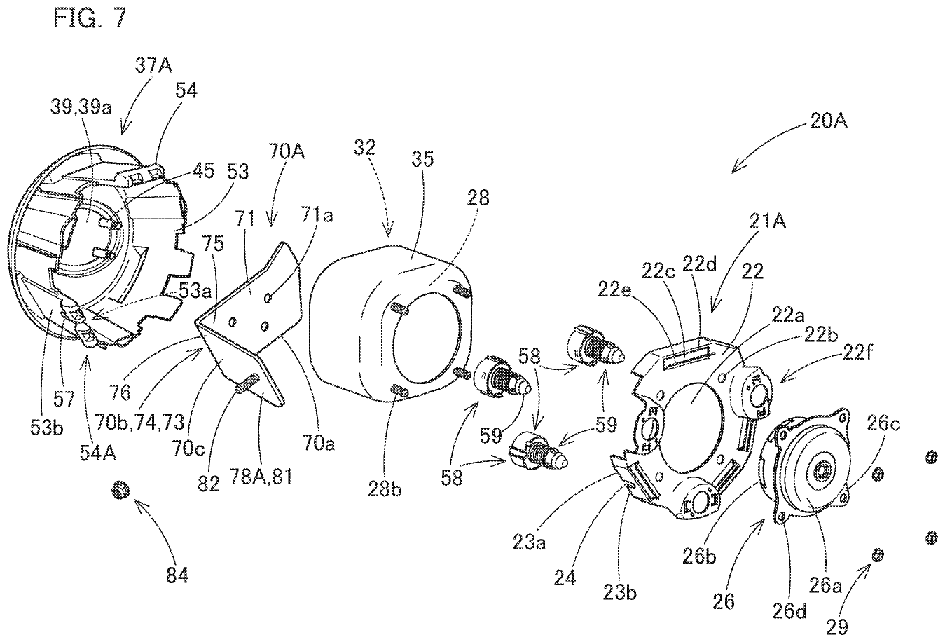

A second exemplary embodiment is now described with reference to FIGS. 7 to 11. In an airbag device 20A in accordance with the second exemplary embodiment, a root-side connecting portion 78A of a holding member 70A is mounted on a holder 21A with a bolt 82 and a nut 84.

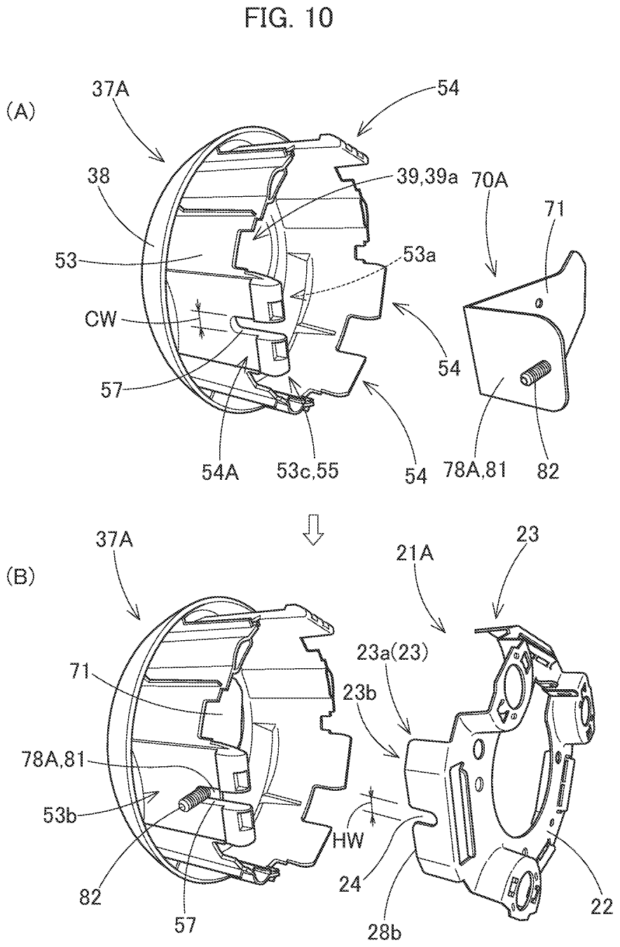

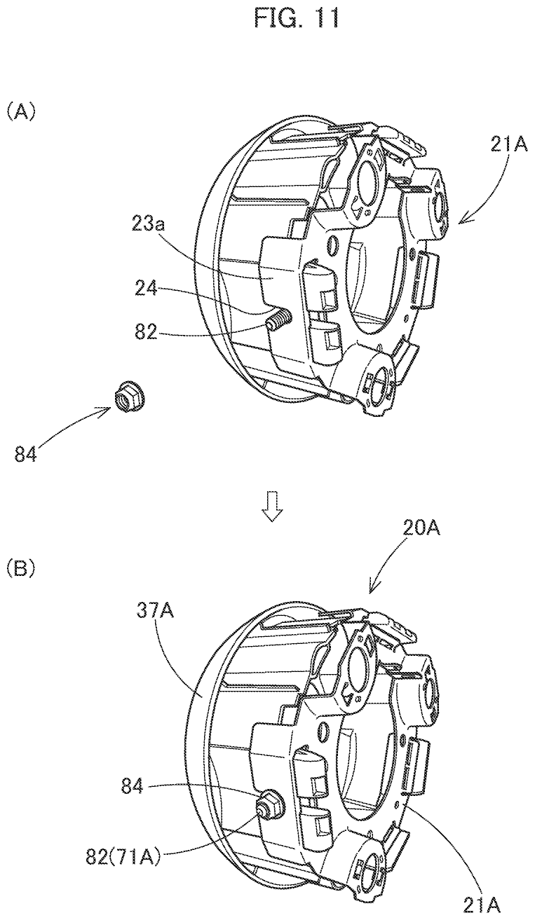

In the second exemplary embodiment, in the holding member 70A, which is formed of a sheet metal and has a L sectional shape, the root-side connecting portion 78A disposed at a lower end portion of the vertical plate portion 70c includes a connecting tongue 81 to be applied to the inner surface 53a of the side wall 53 of the airbag cover 37A, as shown in FIGS. 7 and 10. The connecting tongue 81 includes a bolt 82 that is to protrude from the inner side 53a to the outer side 53b of the side wall 53. As will be described later, the bolt 82 is to put through a holder-side concave channel 24 of the holder 21A to be nut 84 fastened, as shown in FIGS. 7 and 11.

In the side wall 53 of the airbag cover 37A, a retaining leg 54A to be mated with the connecting tongue 81 includes a cover-side concave channel 57 that extends from the leading end (or lower end) 53c toward the door 39.

The holder 21A includes a mounting plate portion 23a in the side wall 23 that extends upward from the bottom wall 22, on which the airbag 32 is mounted, toward the door 39 of the airbag cover 37A, and is to be disposed in the outer side 53b of the retaining leg 54A of the side wall 53 provided with the concave channel 57. The mounting plate portion 23 includes a holder-side concave channel 24 that extends from the leading end (or upper end) 23b toward the bottom wall 22 and serves as a mounting hole.

Each of the cover-side concave channel 57 and holder-side concave channel 24 has a width CW, HW (FIG. 10), respectively, that permits passage of the bolt 82 but prohibits passage of the nut 84.

Other parts of the holding member 70A than the root-side connecting portion 78A such as the distal-side connecting portion 71 for holding the camera 62 and deformable portion 73, other parts of the airbag cover 37A than the retaining leg 54A such as the door 39 provided with the ornament 50 and hinge 40, and other parts of the holder 21A than the mounting plate portion 23a such as the bottom wall 22 provided with the insert hole 22a, have the same configurations as those in the first exemplary embodiment. Those parts are assigned herein with the same reference signs, and are not described in detail.

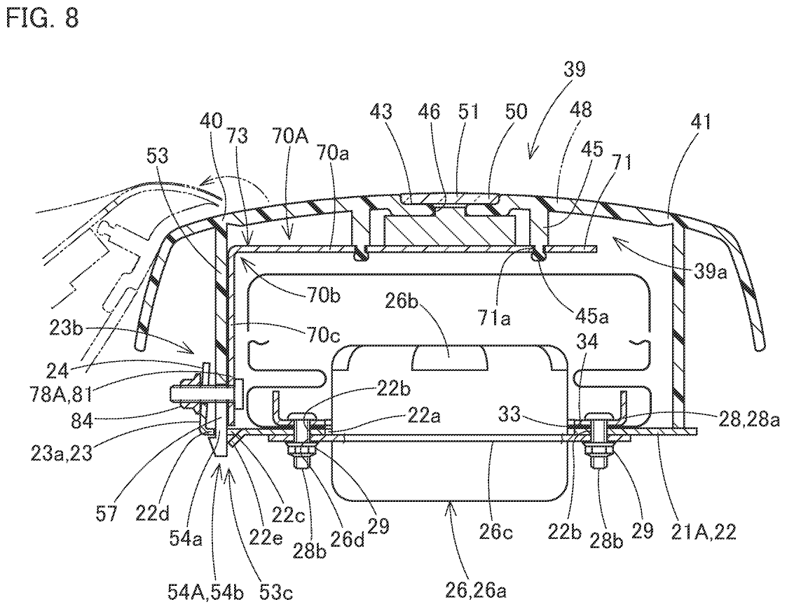

To assemble the airbag device 20A in accordance with the second exemplary embodiment, as shown in FIG. 10, the bolt 82 disposed in the connecting tongue 81 of the root-side connecting portion 78A in the holding member 70A is inserted into the concave channel 57 in the side wall 53 of the airbag cover 37A. At this time, the distal-side connecting portion 71, which has been provided with the camera 62, is coupled to the back surface 39a of the door 39 of the airbag cover 37A with the use of the retaining projections 45, as shown in FIG. 8.

Then the bolt 82 of the connecting tongue 81 is put into the holder-side concave channel 24 in the mounting plate portion 23a of the holder 21A on which the airbag 32, inflator 26 and the horn switch units 58 have been mounted, then fastened with the nut 84 as shown in FIG. 11. Thus, the root-side connecting portion 78A of the holding member 70A is coupled with the holder 21A, as well as the airbag device 20A is completed. FIG. 11 is drawn without the airbag 32, inflator 26 and so on.

The airbag device 20A thus assembled is mounted on the steering wheel body 1 by inserting the mounting pins 59 of the horn switch units 58 into the retaining holes 11 (FIG. 2) of the wheel body 1, as in the first exemplary embodiment. Thus, the airbag device 20A and steering wheel W are mounted on the vehicle.

In operation, in a condition in which the airbag device 20A is not yet activated, the camera 62, which is disposed in the back side 39a of the door 39, photographs the eyes and the vicinity of the driver through the light-transmissive portion 51 of the ornament 50 where the lens 63 is disposed, and sends the shot data to the means for determination, in a similar fashion to the first exemplary embodiment.

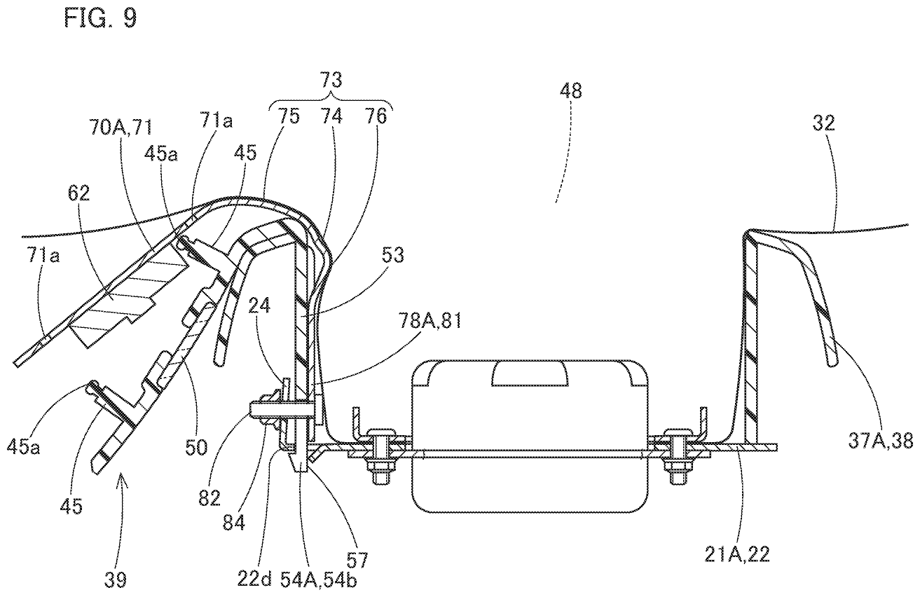

When the airbag device 20A is activated, as shown in FIGS. 8 and 9, the inflator 26 emits an inflation gas from the gas discharge ports 26a, so that the airbag 32 is inflated with the gas, pushes the door 39 of the airbag cover 37A directly or indirectly with the interposition of the camera 32 and distal-side connecting portion 71 of the holding member 70A. Then the breakable portion 41 is broken and the door 39 opens around the hinge 40, thus an airbag emergence opening 48 is formed in the ceiling wall 38 of the airbag cover 37A. At the same time, the distal-side connecting portion 71 of the holding member 70A, which holds the camera 62, is also pushed by the inflating airbag 32, so that the deformable portion 73 of the holding member 70A, i.e. the body 74, the distal-side extended portion 75 and the root-side extended portion 76, is plastically deformed so as to allow the distal-side connecting portion 71 to rotate around the bent portion 70a and the vicinity through the airbag emergence opening 48. At this time, the retaining projections 45 of the door 39 of the airbag cover 37A pull out of the mounting holes 71a, so that the distal-side connecting portion 71 as holding the camera 62 is disengaged from the door 39. Accordingly, the camera 62 disengaged from the door 39 rotates as held by the distal-side connecting portion 71 of the holding member 70, without straining its centrifugal force on the hinge 40 of the door 39.

Therefore, similarly to the first exemplary embodiment, the configuration of the airbag device 20A in accordance with the second exemplary embodiment enables the camera (i.e. the functional component) 62 to be disposed in the door 39, which is openable at airbag deployment, with a least reinforcement of the hinge 40 of the door 39.

In the second exemplary embodiment, although the bolt 82 protrudes from the connecting tongue 81 of the holding member 70A to the outside 53b of the side wall 53 of the airbag cover 37, since the side wall 53 includes the cover-side concave channel 57 that extends from the leading end (lower end) 53c of the side wall 53 towards the door 39 for receiving the bolt 82, the cover-side concave channel 57 is able to receive the bolt 82 therein from the leading end (lower end) 53c of the side wall 53 when the distal-side connecting portion 71 of the holding member 70A as holding the camera (as the functional component) 62 is attached to the door 39. Moreover, the holder 21A also includes the holder-side concave channel 24 that extends from the leading end (or upper end) 23b of the mounting plate portion 23a toward the bottom wall 22 for receiving the bolt 82, so that the holder-side concave channel 24 is able to receive the bolt 82 therein from the leading end (or upper end) 23b of the mounting plate portion 23a when the holder 21A is brought close to the airbag cover 37. Accordingly, the bolt 82 is smoothly made to go through the side wall 53 of the airbag cover 37 and mounting plate portion 23a of the holder 21A at assembling of the airbag device 20A. Furthermore, each of the cover-side concave channel 57 in the side wall 53 and the holder-side concave channel 24 in the mounting plate portion 23a has such a width CW, HW, respectively, that permits passage of the bolt 82 but prohibits passage of the nut 84. Accordingly, the nut 84 secures a sufficient interference for clamping peripheral edges of the cover-side concave channel 57 and holder-side concave channel 24 when the bolt 82 is fastened with the nut 84, so that the root-side connecting portion 78A of the holding member 70A and the side wall 53 of the airbag cover 37A are robustly secured to the holder 21A.

In the second exemplary embodiment, since the bolt 82 for securing the holding member 70A to the holder 21A protrudes outwardly from the root-side connecting portion 78A of the holding member 70A, there is no fear that the airbag 32 would be damaged by the bolt 82. Moreover, since the bolt 82 is designed to go through the side wall 53 of the airbag cover 37A from the inner side 53a to the outer side 53b, the height of the side wall 53 of the airbag cover 37A, i.e. the height of the airbag device 20A, does not have to be increased.

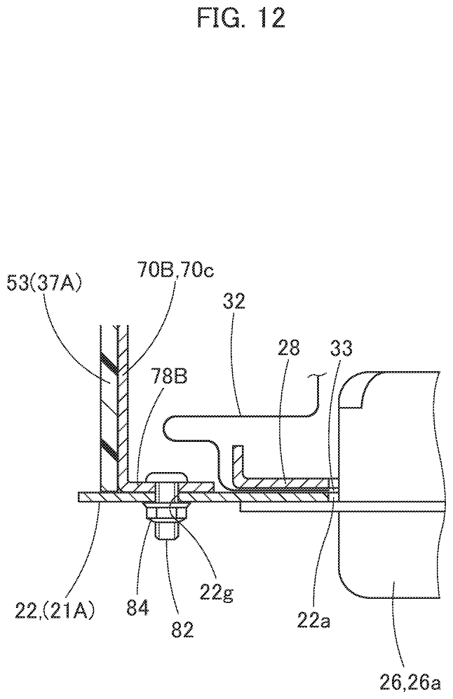

The configuration in which the holding member as holding a functional component is secured to the holder with the use of a bolt formed in the root-side connecting portion of the holding member may be modified as shown in FIG. 12. In FIG. 12, the bolt 82 formed in a root-side connecting portion 78B of a holding member 70B is put through a mounting hole 22g formed in a bottom wall 22 of a holder 21A and fastened with the nut 84. The root-side connecting portion 78B is robustly secured to the holder 21A with this configuration as well.

In the first and second exemplary embodiments, the door 39 of the airbag cover 37, 37A includes the ornament 50 in the front surface, the ornament 50 includes the light-transmissive portion 51, and the lens 63 of the camera 62 is disposed in the back side of the light-transmissive portion 51.

The ornament 50 covers and hides the lens 63 of the camera 62, thus helps keep a good appearance of the airbag cover 37, 37A. The ornament 50 does not hinder photographing since the lens 63 is covered by the light-transmissive portion 51 of the ornament 50.

In the first and second exemplary embodiments, especially, the front surface of the ornament 50 has been subjected to one-way mirror processing. This makes the lens 63 of the camera 62 even less noticeable to the driver.

It would also be conceivable to locate the lens 63 of the camera 62 in the through hole 46 that is merely left open, with no ornament 50 thereon. Further alternatively, a transparent or transparent colored protection plate may be disposed on the through hole 46 instead of the ornament 50.

In the first and second exemplary embodiments, furthermore, the airbag device 20, 20A has been described as mounted on the boss section B of the steering wheel W that is disposed in a vicinity of the center of the grip (or rim portion) R of the steering wheel W. However, the invention may also be applied to any airbag devices in which a functional component such as a camera is disposed in a door of an airbag cover for covering an airbag. By way of example, the invention may be applied to an airbag device for a passenger seat in which a functional component such as a light-emitting device is disposed in a door of an airbag cover.

The airbag device in accordance with an exemplary embodiment includes an airbag that is folded and is configured to unfold and be inflated with an inflation gas; an airbag cover that covers the airbag, the airbag cover including a door that is configured to open around a hinge portion when pushed by the airbag as being inflated, and a side wall that is disposed around the door; a holder that is coupled with the side wall of the airbag cover and holds the airbag and airbag cover; a functional component disposed in the door; and a holding member that is secured to the functional component and holds the functional component, the holding member being plastically deformable. The holding member includes a distal-side connecting portion that is fixed to the functional component, a root-side connecting portion that is secured to the holder, and a deformable portion that is disposed between the distal-side connecting portion and the root-side connecting portion. The deformable portion is configured to be plastically deformed at airbag deployment while having the distal-side connecting portion keep holding the functional component and suppressing a centrifugal force of the functional component from acting on the hinge portion of the door of the airbag cover.

In the airbag device in accordance with the exemplary embodiment, the functional component disposed in the door of the airbag cover is secured to and held by the plastically deformable holding member. When the door is pushed by the airbag and opens around the hinge portion at airbag deployment, the functional component also rotates due to plastic deformation of the deformable portion of the holding member, while the centrifugal force of the functional component is suppressed from acting on the hinge portion of the door. Although the holding member is made from a plastically deformable material, it has shape retention property until being deformed, and is coupled to the robust holder for holding the airbag by the root-side connecting portion. Therefore, the holding member is able to hold the functional component steadily. Further, the holding member facilitates assembling and positioning of the functional component with respect to the door.

Therefore, the configuration of the airbag device in accordance with the exemplary embodiment will enable the functional component to be disposed in the door, which is openable at airbag deployment, with a least reinforcement of the hinge of the door.

In various embodiments, the functional component may be composed of a camera for photographing a vehicle occupant. Although the camera has more weight than other functional components such as a light-emitting device, the configuration of the exemplary embodiment will suppress a centrifugal force of the camera from acting on the hinge of the door considerably, thus will not cause breakage of the hinge, and enable the camera to be disposed in the door with no problem.

In various embodiments, the airbag device may be configured to be mounted on a boss section of a steering wheel that is disposed in a vicinity of a center of a grip of the steering wheel.

In various embodiments, the airbag device may be configured such that:

the side wall of the airbag cover includes a plurality of retaining legs in the leading end, each of the retaining legs including a retaining head that bulges outwardly;

the holder includes a plurality of retaining holes for receiving the retaining legs;

the retaining legs are respectively inserted into the retaining holes so that each of the retaining heads is retained by a retaining edge of each of the retaining holes, the retaining edge being a part of a peripheral edge of the retaining hole;

the root-side connecting portion of the holding member is formed into a hook shape having a generally L sectional shape so as to be engaged with a region from an inner surface of one of the retaining legs to a leading end of the retaining head of the one of the retaining legs; and

the root-side connecting portion is inserted into one of the retaining holes of the holder and secured to the holder together with the one of the retaining legs.

This configuration will facilitate a coupling work of the holding member to the holder. More particularly, if the root-side connecting portion of the holding member having a hook shape has been brought into engagement with the leading end of the retaining head of a predetermined one of the retaining legs before inserting the retaining legs of the airbag cover into the retaining holes of the holder, the root-side connecting portion has only to be inserted into the predetermined retaining hole together with the retaining leg. Doing so will make the the root-side connecting portion of the holding member retained by the holder together with the one of the retaining legs when the retaining heads of the retaining legs are retained by the retaining edges of the retaining holes.

In this case, the holder may further include, in a part of the peripheral edge of each of the retaining holes opposite from the retaining edge, a tongue that is bent towards the retaining hole and presses the retaining leg as inserted through the retaining hole towards the retaining edge. With this configuration, after the retaining legs have been inserted into the retaining holes of the holder, if the tongues are bent to press the retaining legs toward the retaining edges, the engagement between the retaining heads of the retaining legs and the retaining edges of the retaining holes in the holder becomes stronger. As for the retaining leg that is inserted into the retaining hole with the root-side connecting portion of the holding member, the coupling of the root-side connecting portion and the holder becomes stronger as well.

In various embodiments, the airbag device may be configured such that:

the root-side connecting portion of the holding member includes a bolt;

the holder includes a mounting hole for receiving the bolt; and

the root-side connecting portion is secured to the holder by fastening the bolt as inserted through the mounting hole with a nut.

With this configuration, the root-side connecting portion of the holding member is solidly secured to the holder by inserting the bolt in the root-side connecting portion into the mounting hole of the holder and fastening the bolt with the nut.

In this case, the airbag device may be configured such that:

the root-side connecting portion of the holding member includes a connecting tongue that is disposed on an inner surface of the side wall of the airbag cover;

the bolt is disposed in the connecting tongue to protrude from an inner side to an outer side of the side wall of the airbag cover;

the side wall of the airbag cover includes a cover-side concave channel that extends from a leading end of the side wall toward the door for receiving the bolt;

the holder includes a bottom wall on which the airbag is mounted, and a mounting plate portion that extends upward from the bottom wall toward the door of the airbag cover and is disposed on outside of the cover-side concave channel;

the mounting plate portion includes a holder-side concave channel that extends from a leading end of the mounting plate portion towards the bottom wall and constitutes the mounting hole for receiving the bolt; and

each of the cover-side concave channel and the holder-side concave channel has a width that permits passage of the bolt but prohibits passage of the nut.

With this configuration, if the bolt disposed in the connecting tongue of the root-side connecting portion in the holding member is inserted into the cover-side concave channel in the side wall of the airbag cover and the holder-side concave channel in the mounting plate portion of the holder, then fastened with the nut, the root-side connecting portion of the holding member is coupled with the holder. Although the bolt protrudes from the connecting tongue of the holding member to the outside of the side wall of the airbag cover, since the side wall includes the cover-side concave channel that extends from the leading end of the side wall towards the door for receiving the bolt, the cover-side concave channel is able to receive the bolt therein from the leading end of the side wall when the distal-side connecting portion as holding the functional component is attached to the door. Moreover, the holder also includes the holder-side concave channel that extends from the leading end of the mounting plate portion toward the bottom wall for receiving the bolt, so that the holder-side concave channel is able to receive the bolt therein from the leading end of the mounting plate portion when the holder is brought close to the airbag cover. Accordingly, the bolt is smoothly made to go through the side wall of the airbag cover and mounting plate portion of the holder at assembling of the airbag device. Furthermore, each of the cover-side concave channel in the side wall and the holder-side concave channel in the mounting plate portion has such a width that permits passage of the bolt but prohibits passage of the nut. Accordingly, the nut secures a sufficient interference for clamping peripheral edges of the cover-side concave channel and holder-side concave channel when the bolt is fastened with the nut, so that the root-side connecting portion of the holding member and the side wall of the airbag cover are robustly secured to the holder. Moreover, since the bolt protrudes outwardly from the root-side connecting portion of the holding member, there is no fear that the airbag would be damaged by the bolt. Further, since the bolt is designed to go through the side wall of the airbag cover from the inner side to the outside, the height of the side wall of the airbag cover, i.e. the height of the airbag device, does not have to be increased.

What is claimed is:

1. An airbag device adapted to be mounted on a vehicle, comprising:
an airbag that is folded and is configured to unfold and be inflated with an inflation gas;
an airbag cover that covers the airbag, the airbag cover including a door that is configured to open around a hinge portion when pushed by the airbag as being inflated, and a side wall that is disposed around the door;
a holder that is coupled with the side wall of the airbag cover and holds the airbag and airbag cover;
a functional component disposed in the door; and
a holding member that is secured to the functional component and holds the functional component, the holding member being plastically deformable and including:
a distal-side connecting portion that is secured to the functional component;
a root-side connecting portion that is secured to the holder; and
a deformable portion that is disposed between the distal-side connecting portion and the root-side connecting portion, the deformable portion being configured to be plastically deformed at airbag deployment while having the distal-side connecting portion keep holding the functional component and suppressing a centrifugal force of the functional component from acting on the hinge portion of the door of the airbag cover.

2. The airbag device of claim 1, wherein the functional component is a camera for photographing a vehicle occupant.

3. The airbag device of claim 1 configured to be mounted on a boss section of a steering wheel that is disposed in a vicinity of a center of a grip of the steering wheel.

4. The airbag device of claim 1, wherein:
the side wall of the airbag cover includes a plurality of retaining legs in the leading end, each of the retaining legs including a retaining head that bulges outwardly;
the holder includes a plurality of retaining holes for receiving the retaining legs;
the retaining legs are respectively inserted into the retaining holes so that each of the retaining heads is retained by a retaining edge of each of the retaining holes, the retaining edge being a part of a peripheral edge of the retaining hole;
the root-side connecting portion of the holding member is formed into a hook shape having a generally L sectional shape so as to be engaged with a region from an inner surface of one of the retaining legs to a leading end of the retaining head of the one of the retaining legs; and
the root-side connecting portion is inserted into one of the retaining holes of the holder and secured to the holder together with the one of the retaining legs.

5. The airbag device of claim 4, wherein the holder includes, in a part of the peripheral edge of each of the retaining holes opposite from the retaining edge, a tongue that is bent towards the retaining hole and presses the retaining leg as inserted through the retaining hole towards the retaining edge.

6. The airbag device of claim 1, wherein:
the root-side connecting portion of the holding member includes a bolt;
the holder includes a mounting hole for receiving the bolt; and
the root-side connecting portion is secured to the holder by fastening the bolt as inserted through the mounting hole with a nut.

7. The airbag device of claim 6, wherein:
the root-side connecting portion of the holding member includes a connecting tongue that is disposed on an inner surface of the side wall of the airbag cover;
the bolt is disposed in the connecting tongue to protrude from an inner side to an outer side of the side wall of the airbag cover;
the side wall of the airbag cover includes a cover-side concave channel that extends from a leading end of the side wall toward the door for receiving the bolt;
the holder includes a bottom wall on which the airbag is mounted, and a mounting plate portion that extends upward from the bottom wall toward the door of the airbag cover and is disposed on outside of the cover-side concave channel;
the mounting plate portion includes a holder-side concave channel that extends from a leading end of the mounting plate portion towards the bottom wall and constitutes the mounting hole for receiving the bolt; and
each of the cover-side concave channel and the holder-side concave channel has a width that permits passage of the bolt but prohibits passage of the nut.
